(19) United States
(12) Patent Application Publication
(10) Pub. No.: US 2014/0301745 A1
(43) Pub. Date: Oct. 9, 2014

(54) IMAGE FORMING APPARATUS, IMAGE FORMING METHOD, AND MEDIUM

(71) Applicant: CANON KABUSHIKI KAISHA, Tokyo (JP)

(72) Inventor: Ryosuke Otani, Tokyo (JP)

(73) Assignee: CANON KABUSHIKI KAISHA, Tokyo (JP)

(21) Appl. No.: 14/231,994

(22) Filed: Apr. 1, 2014

(30) Foreign Application Priority Data
Apr. 5, 2013 (JP) 2013-079422

(51) Int. Cl. G03G 15/00

(52) U.S. Cl. CPC G03G 15/5025
USPC 399/15

(57) ABSTRACT

There is provided an image forming apparatus for forming an image using coloring materials of a plurality of colors. The image forming apparatus includes a regular reflection light measuring unit configured to measure regular reflection light of an image formed by a coloring material of a color with which a difference in diffused reflection light between a non-image part and an image part on a recording medium is relatively small compared to a difference in specular reflection light of the coloring materials of the plurality of colors at an angle by which a quantity of received light to be measured by a light receiving unit becomes stable in a case where distance between the light receiving unit and a measurement surface varies and a glossiness determining unit configured to determine glossiness based on the intensity of regular reflection light measured by the regular reflection light measuring unit.

### BACKGROUND OF THE INVENTION

1. Field of the Invention

The present invention relates to an image forming apparatus, an image forming method, and a medium.

2. Description of the Related Art

In an image forming apparatus, such as a copy machine and a printer, an image is formed by attaching a coloring material onto a sheet and a plurality of gradations is represented by changing the area of attached coloring material (area coverage modulation). Because of this, in the case where the glossiness of a non-image part (part to which no coloring material is attached) and the glossiness of an image part to which a coloring material is attached are different, there occurs a difference in gloss depending on the gradation even within the same image, and therefore, the gloss uniformity is marred.

In general, in order to increase the gloss uniformity, the glossiness of the non-image part and the glossiness of the image part are grasped in advance for each type of sheet and the glossiness of the image part is controlled so that the difference between the glossiness of the non-image part and the glossiness of the image part becomes small in accordance with the type of sheet to be used. As the method for controlling the glossiness of the image part, mention is made of, for example, a method for changing the smoothness of the surface of a coloring material by controlling the fixing temperature and the fixing rate of the coloring material and a method for controlling gloss by forming an image using a transparent coloring material.

However, in recent years, in order to improve the texture of printed matter or to improve gloss, the types of sheet to be used have diversified, and therefore, there is such a problem that it is difficult to acquire in advance the glossiness of the non-image part and the glossiness of the image part for all the types of sheet. As a technique to solve this problem, the technique has been disclosed (for example, see Japanese Patent Laid-Open No. 2004-70010 and Japanese Patent Laid-Open No. 2005-321643), in which a gloss meter is provided within the image forming apparatus and the image forming conditions are set so as to improve the gloss uniformity by detecting the glossiness of the image part in the post-process of fixing.

Japanese Patent Laid-Open No. 2004-70010 describes the image forming apparatus for forming a full-color image in which the gloss on the surface of the same image is uniform and which gives a favorable impression by setting the image forming conditions so that the difference in glossiness, which is the difference between the maximum glossiness within the image and the minimum glossiness within the image, becomes equal to or less than a predetermined value.

A glossiness measuring method described in Japanese Patent Laid-Open No. 2004-70010 is known. That is, in this method, a light source and a light receiving unit are installed so that an incidence angle θ and a light reception angle θ′ are equal with respect to the normal of the surface to be measured (hereinafter, measurement surface) and light is caused to enter from the light source and the light regularly reflected is measured by the light receiving unit. In the embodiment of Japanese Patent Laid-Open No. 2004-70010, glossiness is detected with the incidence angle θ being set to 60 degrees.

Japanese Patent Laid-Open No. 2005-321643 describes the image forming system capable of outputting an image in which variations in image quality due to the change in glossiness are suppressed to a minimum by controlling the glossiness of the output image with the glossiness measured in a large area of a reference image as a reference. Japanese Patent Laid-Open No. 2005-321643 has proposed the glossiness measuring method that enables measurement of glossiness with high accuracy by setting the incidence angle θ to 20 degrees or less even in the case where the distance between the glossiness measuring apparatus and the measurement surface is increased.

### SUMMARY OF THE INVENTION

However, the above-mentioned prior arts have problems described below.

In the case where glossiness is measured during the period of sheet conveyance within the image forming apparatus using the method described in Japanese Patent Laid-Open No. 2004-70010, it is not possible to cause the glossiness measuring apparatus and the measurement surface to come into contact with each other. Consequently, the distance between the glossiness measuring apparatus and the measurement surface varies due to floating or twisting of a sheet, or vibrations of the measurement surface. Because of this, the glossiness measuring method (60-degree glossiness) described in Japanese Patent Laid-Open No. 2004-70010 has such a problem that the magnitude of deviation between the center of the light reflected from the measurement surface in the regular reflection direction and the center of the light receiving unit is great, and therefore, it is not possible to stably measure glossiness.

On the other hand, with the glossiness measuring method described in Japanese Patent Laid-Open No. 2005-321643, by setting the incidence angle θ to 20 degrees or less, measurement of glossiness with high accuracy is enabled even in the case where the distance between the glossiness measuring apparatus and the measurement surface varies. However, in the case where the incidence angle θ is set to a deep angle, there is such a problem that the measurement accuracy of glossiness is reduced due to diffused reflection light that is absorbed and scattered inside the image and then emitted from the image surface. In particular, in the case of a coloring material with which the difference in diffused reflection light between the non-image part and the image part is large, a change in the quantity of diffused light caused by gradation affects the measurement value of glossiness and there has been such a problem that it is not possible to measure glossiness with high accuracy.

The present invention has been made in view of the above-mentioned problems and an object of the present invention is to provide an image forming apparatus capable of acquiring glossiness of an image stably and with high accuracy.

In the present specification, an incidence angle far from the normal of the measurement surface is described as a “shallow” incidence angle and an incidence angle near to the normal of the measurement surface as a “deep” incidence angle.

The present invention is an image forming apparatus for forming an image using coloring materials of a plurality of colors and includes a measuring unit configured to measure regular reflection light of an image formed by a coloring material of a color with which a difference in diffused reflection light between a non-image part and an image part on a recording medium is relatively small compared to a difference in specular reflection light of the coloring materials of the plurality of colors at an angle by which a quantity of received light to be measured by a light receiving unit becomes stable in a case where distance between the light receiving unit and a measurement surface varies and a determining unit configured to determine glossiness based on the intensity of the regular reflection light measured by the measuring unit.

According to the present invention, it is possible to measure glossiness stably and with high accuracy and control of gloss accompanied by the gloss uniformity with high accuracy is enabled.

Further features of the present invention will become apparent from the following description of exemplary embodiments (with reference to the attached drawings).

### BRIEF DESCRIPTION OF THE DRAWINGS

FIG. 1 a block diagram for explaining a configuration of an image forming system according to a first embodiment of the present invention;

FIG. 2 is a diagram showing a configuration of an image forming apparatus according to the first embodiment of the present invention;

FIG. 3 is a schematic configuration diagram showing a configuration of a regular reflection light measuring apparatus according to the first embodiment of the present invention;

FIG. 4 is a flowchart for explaining a measurement process of glossiness according to the first embodiment of the present invention;

FIG. 5 is an example of a pattern image for measuring glossiness according to the first embodiment of the present invention;

FIG. 6 is a schematic configuration diagram for explaining a configuration of the regular reflection light measuring apparatus in the case where an incidence angle θ is set to 60 degrees;

FIG. 7 is a schematic configuration diagram for explaining a configuration of the regular reflection light measuring apparatus in the case where the incidence angle θ is set to 20 degrees;

FIG. 8 is a graph representing an intensity distribution of reflection light in the regular reflection direction with a light reception angle θ′ as a center in the case where light is caused to enter the measurement surface at the incidence angle θ;

FIG. 9A and FIG. 9B are graphs each representing a glossiness characteristic in a K monochrome gradation pattern image;

FIG. 10 is a graph representing the spectral radiance of a light source equivalent to a coupling of a D65 light source, which is the standard light source, and the spectral luminous efficiency;

FIG. 11 is a graph representing the spectral reflectance for a non-image part and a solid image of toner of each of C, M, Y, and K;

FIG. 12 is a graph representing the spectral radiance of diffused reflection light for the non-image part and the solid image of toner of each of C, M, Y, and K;

FIG. 13A and FIG. 13B are graphs each representing a glossiness characteristic in a Y monochrome gradation pattern image;

FIG. 14 is a diagram showing a configuration of an image forming apparatus according to a second embodiment of the present invention;

FIG. 15 is a schematic configuration diagram showing a configuration of a regular reflection light measuring apparatus according to the second embodiment of the present invention;

FIG. 16 is a flowchart for explaining a measurement process of glossiness according to the second embodiment of the present invention;

FIG. 17 is a schematic configuration diagram showing a configuration of a regular reflection light measuring apparatus according to a third embodiment of the present invention; and

FIG. 18 is a flowchart for explaining a measurement process of glossiness according to the third embodiment of the present invention.

### DESCRIPTION OF THE EMBODIMENTS

Hereinafter, with reference to the drawings, embodiments of the present invention are explained. Note that the same reference number refers to the same element in the present specification.

In the embodiments explained below, explanation is given with a printer by taking the electrophotographic recording system as an example, however, the present invention can be applied to a printer using another recording system in which an image is formed by attaching coloring materials onto the surface of a sheet. Further, the present invention can also be applied to an apparatus other than a printer as long as the apparatus includes a printer.

### First Embodiment

First, image processing by an image forming apparatus using the electrophotographic recording system according to the present embodiment is explained.

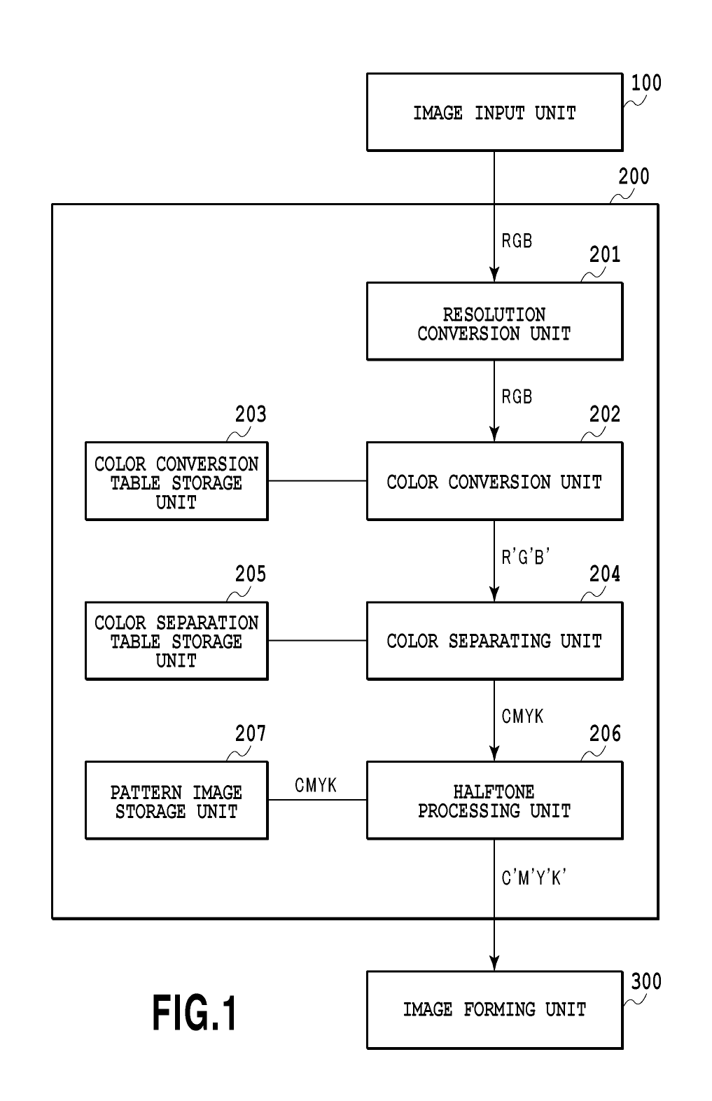

FIG. 1 is a block diagram for explaining a configuration of an image forming system according to the present embodiment. As shown in FIG. 1, the image forming system includes an image input unit 100, an image processing unit 200, and an image forming unit 300.

The image input unit 100 is implemented by, for example, application software that operates on a host computer, and transmits image data to the image processing unit 200.

The image processing unit 200 includes a resolution conversion unit 201, a color conversion unit 202, a color conversion table storage unit 203, a color separation unit 204, a color separation table storage unit 205, a halftone processing unit 206, and a pattern image storage unit 207.

The image processing unit 200 converts input image data received from the image input unit 100 into print data. Conversion from the input image data into the print data is carried out by the resolution conversion unit 201, the color conversion unit 202, the color separation unit 204, and the halftone processing unit 206. The print data converted from the input image data by the image processing unit 200 is input to the image forming unit 300. Details of the image forming unit 300 will be described later.

The resolution conversion unit 201 converts the resolution of the input image data into the data processing resolution of the image forming unit 300 and outputs the resolution. As an example, a case is discussed where the data processing resolution of the image forming unit 300 is taken to be 600 dpi and the input image data is taken to be 8-bit RGB data of 300 dpi. In this case, the input image data is represented by a set of pixels with a width of 1/300 inches and each pixel includes three kinds of signals, red (R), green (G), and blue (B), which take a value from 0 to 255. The resolution conversion unit 201 converts the input image data (i.e. 8-bit RGB data of 300 dpi) into image data of 600 dpi by, for example, the bi-cubic method, which is a publicly-known resolution conversion method.

The color conversion unit 202 refers to a color conversion table stored in the color conversion table storage unit 203 and converts color signals (R, G, B) configuring the image data output from the resolution conversion unit 201 into color signals (R′, G′, B′) depending on the image forming unit 300 and outputs the color signals. The color signals R′, G′, and B′ are, for example, 8-bit signals, respectively, and take a value from 0 to 255. In the color conversion table stored in the color conversion table storage unit 203, the color signals (R′, G′, B′) corresponding to the discrete color signals (R, G, B) are described. The color signals (R, G′, B′) are calculated by the publicly-known three-dimensional lookup table method (hereinafter, abbreviated to 3DLUT method) using the color conversion table. A preferred configuration is such that a plurality of color conversion tables in accordance with the kinds of recording media and the purposes of image recording is prepared and it is possible to select an appropriate color conversion table in accordance with the kind of recording medium or the purpose of image recording.

The color separation unit 204 refers to a color separation table stored in the color separation table storage unit 205 and converts the color signals (R′, G′, B′) into coloring material amount signals (C, M, Y, K) related to the number of record dots of each coloring material and outputs the coloring material amount signals (the coloring material amount signal is also referred to as coloring material amount data). The coloring material amount signals C, M, Y, and K are, for example, 8-bit signals, respectively, and take a value from 0 to 255.

The halftone processing unit 206 converts the 8-bit (0 to 255) data of the color signal values C, M, Y, and K determined by the color separation unit 204 into one-bit (0 to 1) data, i.e. binary data (C′, M′, Y′, K′) that the image forming unit 300 can record. In general, conversion into binary data can be carried out using the dither method or the error diffusion method. In the case where a user specifies glossiness measurement in a printer driver (not shown in FIG. 1), a pattern image is read from the pattern image storage unit 207 and converted into binary print data in the halftone processing unit 206. The detailed operation of glossiness measurement will be described later.

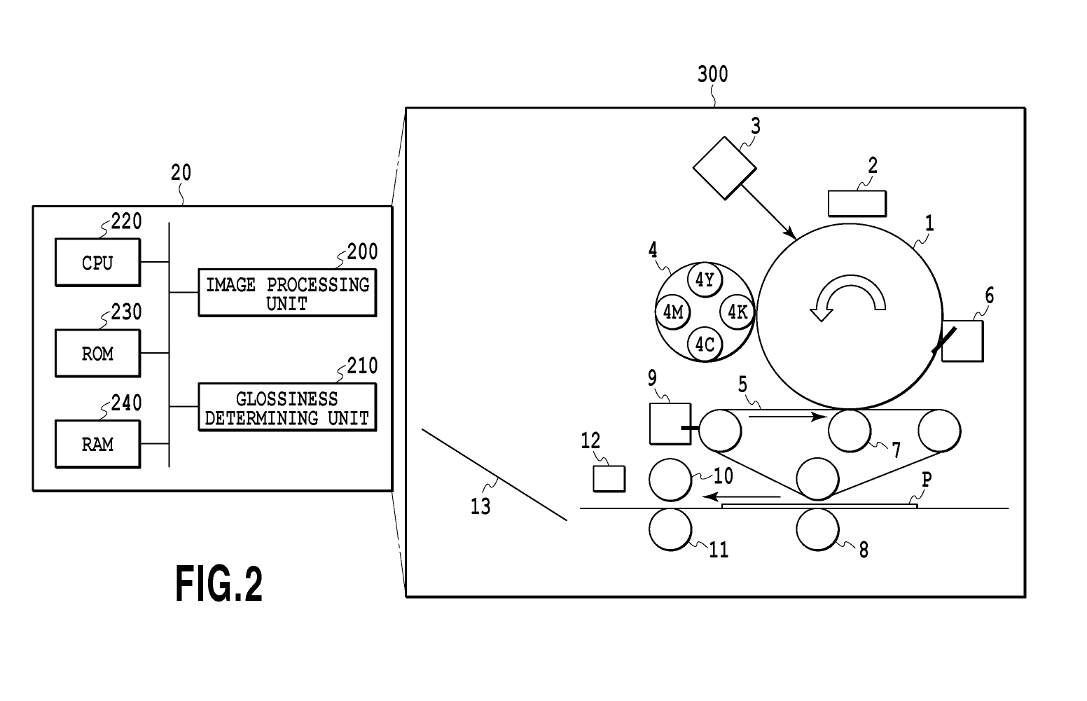

Next, with reference to FIG. 2, a configuration example of the image forming unit 300 in FIG. 1 is explained in detail. FIG. 2 is a diagram showing the configuration of the image forming apparatus according to the present embodiment.

As shown in FIG. 2, around a photosensitive drum 1, a charging apparatus 2, an exposing apparatus 3, a developing apparatus 4, an intermediate transfer belt 5, a photosensitive drum cleaner 6, and a primary transfer apparatus 7 are arranged. Around the intermediate transfer belt 5, a secondary transfer apparatus 8 and an intermediate transfer belt cleaner 9 are arranged. Behind the secondary transfer apparatus 8, a fixing roller 10, an opposing roller 11, a regular reflection light measuring apparatus 12, and a discharge tray 13 are arranged.

The surface of the photosensitive drum 1 is charged uniformly to a predetermined potential by the charging apparatus 2. The exposing apparatus 3 radiates exposure light (for example, laser light) upon receipt of image data. The radiated exposure light is exposed and scanned onto the photosensitive drum 1 rotating in the arrow direction in FIG. 2 through a polygon mirror and a fθ lens (these are not shown in FIG. 2). Due to this, an electrostatic latent image in accordance with the image data is formed on the photosensitive drum 1. This electrostatic latent image is developed into a visible image (toner image) by toner supplied from the developing apparatus 4. The developing apparatus in the present embodiment is a so-called rotary developing apparatus and includes color developing units 4K, 4Y, 4C, and 4M corresponding to toner of each color of black (K), cyan (C), magenta (M), and yellow (Y). At the time of color image formation, each color developing unit moves sequentially to a development position in opposition to the photosensitive drum and performs development. It may also be possible to adopt a system in which each color developing unit is arranged side by side on the circumferential surface of the photosensitive drum 1 or a so-called tandem developing system in which the photosensitive drum for each color developing unit is arranged side by side around the intermediate transfer belt. The developing apparatus may be an apparatus using either the single-component or double-component system. The toner image developed on the photosensitive drum 1 is transferred onto the intermediate transfer belt 5 hooked with tension between a plurality of rollers and endlessly driven by the action of the primary transfer apparatus 7. The toner remaining on the photosensitive drum 1 is removed by the photosensitive drum cleaner 6 and the residual potential remaining on the photosensitive drum 1 is removed by a charge neutralizer (not shown in FIG. 2). This operation is repeated while moving each color developing unit (4K, 4Y, 4C, 4M) used in the developing apparatus 4. Then, the toner image sequentially transferred onto the intermediate transfer belt 5 and including toner of a plurality of colors is transferred onto a recording medium P conveyed from the feed tray (not shown in FIG. 2) by the secondary transfer apparatus 8. The toner remaining on the intermediate transcription belt 5 is removed by the intermediate transfer belt cleaner 9. It is possible to change the temperature of the fixing roller 10 and that of the opposing roller 11, respectively, by controlling a built-in heater (not shown in FIG. 2). Further, the image forming unit 300 is configured so as to be capable of changing the pressure between the fixing roller 10 and the opposing (pressurizing) roller 11 by a pressurizing unit (not shown in FIG. 2). The recording medium P, onto which a toner image not fixed yet is transferred, conveyed from the secondary transfer apparatus 8 is given heat and pressure while the recording medium P passes through between the fixing roller 10 and the opposing roller 11, thereby the toner image is fixed. The regular reflection light measuring apparatus 12 installed in the vicinity of the conveyance path that the recording medium P passes after the fixing process measures the intensity of regular reflection light of the formed toner fixed image in accordance with whether or not there are instructions to perform glossiness measurement. The vicinity of the conveyance path, which is the place where the regular reflection light measuring apparatus 12 is set, refers to a position distant from the conveyance path by a certain distance that enables measurement of glossiness of the toner image on the recording medium that is conveyed. The configuration of the regular reflection light measuring apparatus 12 will be described later. The toner fixed image is discharged from the discharge tray 13 after the measurement of glossiness.

Each component of the image forming unit 300 is controlled by a controller 20 including a central processing unit (CPU) 220, a ROM 230 storing control programs, and a RAM 240 providing a storage area of input data and a work storage area. The controller 20 includes the image processing unit 200 configured to convert input image data into print data for producing an output by a printer by performing various kinds of processing on the input image data, and a glossiness determining unit 210 configured to determine glossiness from the intensity of regular reflection light measured by the regular reflection light measuring apparatus 12.

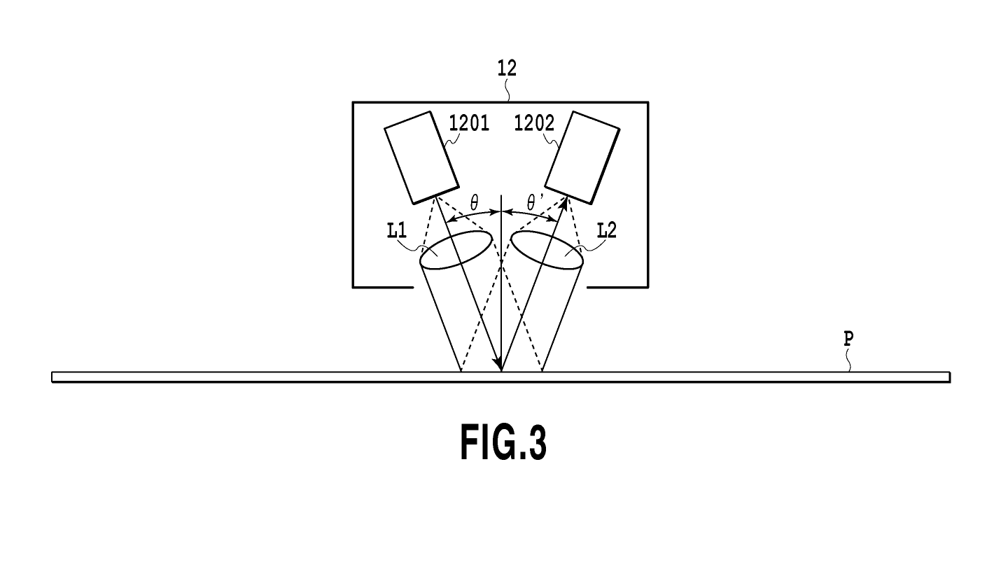

Next, a configuration example of the regular reflection light measuring apparatus 12 in FIG. 2 is explained in detail. FIG. 3 is a schematic configuration diagram showing the configuration of the regular reflection light measuring apparatus 12 in FIG. 2. As shown in FIG. 3, the regular reflection light measuring apparatus 12 includes a light emitting unit 1201, a lens L1, a lens L2, and a light receiving unit 1202. Glossiness is measured by arranging the light emitting unit 1201 and the light receiving unit 1202 so that the incidence angle θ and the light reception angle θ′ are equal with respect to the normal of a measurement surface P, by causing light to enter the measurement surface P from the light emitting unit 1201, and by measuring light that is regularly reflected by the light receiving unit 1202. The light irradiated from the light emitting unit 1201 is turned into parallel light through the lens L1 and this parallel light enters the measurement surface P at the angle θ. Then, the light reflected in the regular reflection direction is condensed through the lens L2 and the condensed light is measured by the light receiving unit 1202.

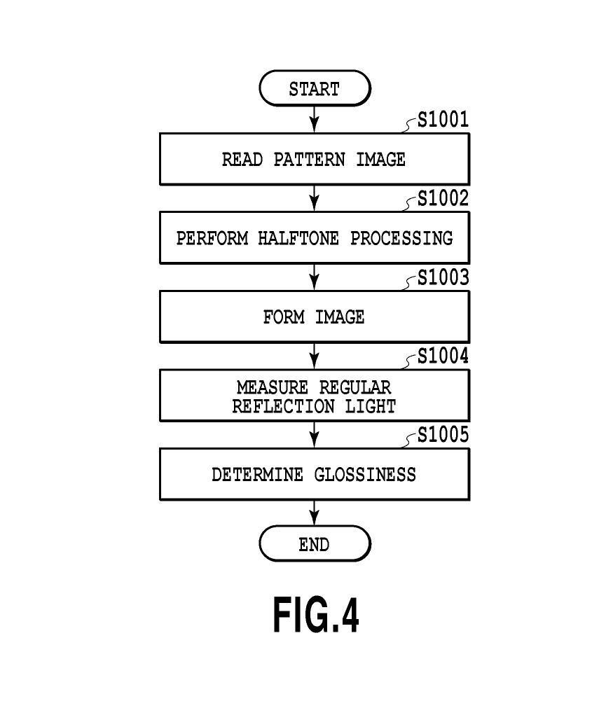

Next, the process of the operation until glossiness of a gradation image is acquired in the image forming system according to the present embodiment is explained. FIG. 4 is a flowchart for explaining a glossiness measurement process. By a user specifying measurement of glossiness in the printer driver (shown neither in FIG. 1 nor in FIG. 2), measurement of glossiness is performed.

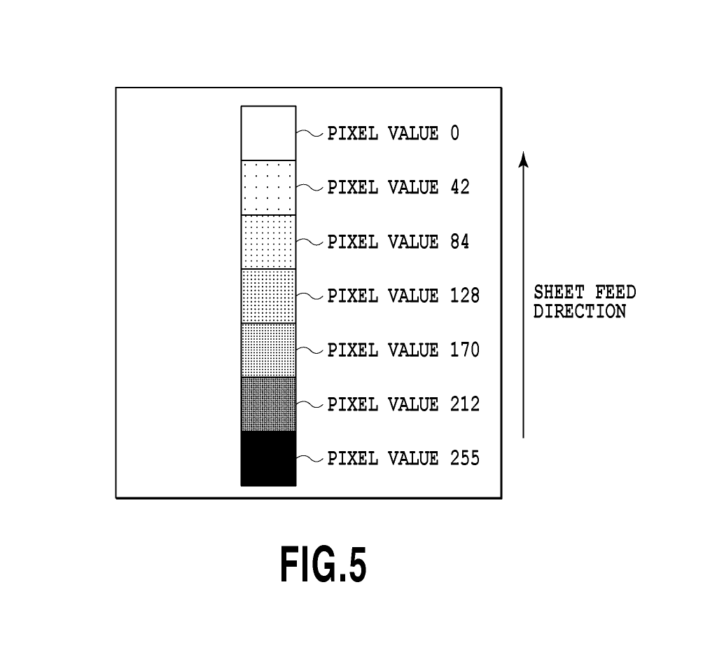

First, pattern image data for measuring glossiness is read from the pattern image storage unit 207 (step S1001). FIG. 5 shows an example of the pattern image. As shown in FIG. 5, patch images with different gradations are arranged side by side in parallel to the sheet feed direction so that glossiness for each gradation can be measured sequentially. The pattern image is formed by the toner of a color with which the difference in diffused reflection light between the non-image part and the image part is sufficiently small compared to the difference in specular reflection light between the non-image part and the image part of the toner of a plurality of colors. Details of the toner selection method will be described later.

The pattern image data that is read is subjected to halftone processing by the halftone processing unit 206 and converted into binary data (step S1002).

The image data converted into binary data in the halftone processing unit 206 is sent to the image forming unit 300 and a toner image is formed through each step of exposure, development, transfer, and fixing via the configuration of the image forming unit 300 shown in the explanation in FIG. 2 (step S1003).

Next, the intensity of regular reflection light of the formed patch image with each gradation is measured by the regular reflection light measuring apparatus 12 (step S1004).

Next, the glossiness determining unit 210 determines the glossiness of each kind of toner from the intensity of regular reflection light of the toner image measured at step 1004 (step S1005).

In the present embodiment, the measured intensity of regular reflection light is determined as glossiness, however, it may also be possible to use an LUT created in advance or a value obtained by conversion using a conversion expression. Further, the conversion LUT and the conversion expression may be the same regardless of toner or may be different for each toner.

(Reason for Glossiness Measurement with Deep Incidence Angle)

In the measurement of regular reflection light in the image forming apparatus of the present invention, it is desired to set the incidence angle of light incident on the measurement surface as deep as possible. The reason for that is explained below by showing an example of measurement of regular reflection light in the case of a shallow incidence angle and an example of measurement of regular reflection light in the case of a deep incidence angle.

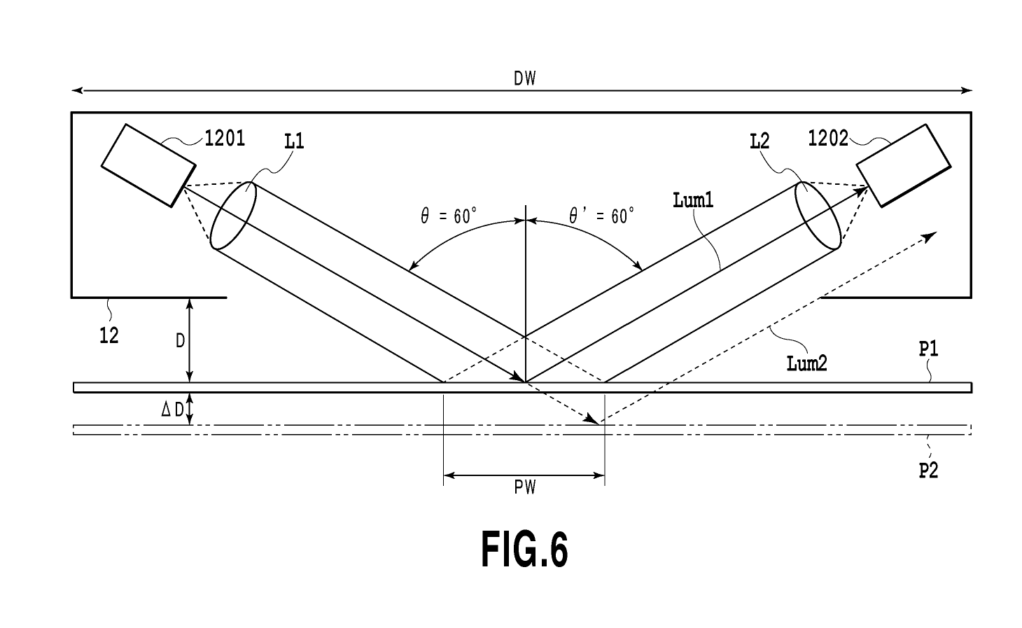

First, an example is shown in which regular reflection light is measured with a shallow incidence angle. FIG. 6 is a schematic configuration diagram showing a configuration of the regular reflection light measuring apparatus 12 in the case where the incidence angle θ is set to 60 degrees as a shallow incidence angle. The light emitting unit 1201 and the lens L1 are arranged 60 degrees inclined with respect to the normal of a measurement surface P1 and the lens L2 and the light receiving unit 1202 in opposition thereto are arranged 60 degrees inclined in the opposite direction of the light emitting unit 1201 with respect to the normal of the measurement surface P1.

Normally, light irradiated from the light emitting unit 1201 turns into parallel light through the lens L1 and is reflected from the measurement surface P1 in the position a specified distance D apart from the regular reflection light measuring apparatus 12 and light Lum1 reflected in the regular reflection direction is condensed through the lens L2 and measured by the light receiving unit 1202.

However, in the case where measurement of glossiness is performed without causing the light measuring apparatus and the measurement surface to come into contact with each other during the period of conveyance of a sheet in the image forming apparatus, the distance from the regular reflection light measuring apparatus to the measurement surface varies due to floating or twisting of the sheet or vibrations of the apparatus etc. The measurement surface P1 in FIG. 6 is a measurement surface located in a position the specified distance D apart from the regular reflection light measuring apparatus 12. A measurement surface P2 in FIG. 6 is a measurement surface located in a position where the distance from the regular reflection light measuring apparatus 12 to the measurement surface has varied from the specified distance D by ΔD.

In the case where incidence light is irradiated at a shallow incidence angle and the distance to the measurement surface has varied, the width of deviation between the center of the reflection light reflected in the regular reflection direction as shown by Lum2 in FIG. 6 and the center of the light receiving unit 1202 is great, and therefore, the quantity of received light to be measured by the light receiving unit 1202 is not stable. The shallower the incidence angle, the greater the width of deviation is, and the deeper, the smaller.

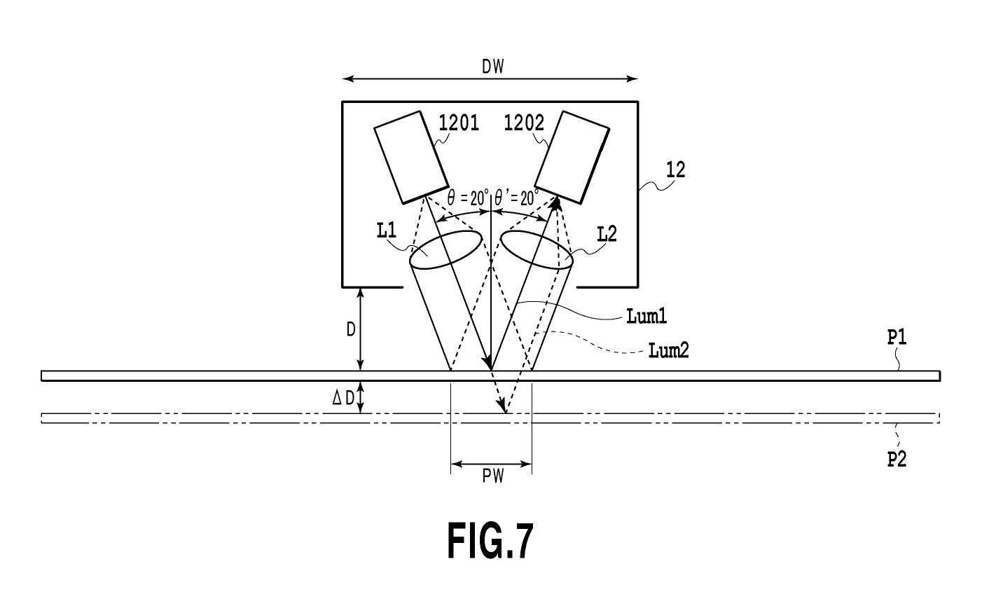

Next, an example is shown in which regular reflection light is measured with a deep incidence angle. FIG. 7 is a schematic configuration diagram showing a configuration of the regular reflection light measuring apparatus 12 in the case where the incidence angle θ is set to 20 degrees as a deep incidence angle. The light emitting unit 1201 and the lens L1 are arranged 20 degrees inclined with respect to the normal of the measurement surface P1 and the lens L2 and the light receiving unit 1202 in opposition thereto are arranged 20 degrees inclined in the opposite direction of the light emitting unit 1201 with respect to the normal of the measurement surface P1. The measurement surface P1 in FIG. 7 is the measurement surface located in the position the specified distance D apart from the regular reflection light measuring apparatus 12. The measurement surface P2 in FIG. 7 is the measurement surface located in the position where the distance from the regular reflection light measuring apparatus 12 to the measurement surface has varied from the specified distance D by ΔD.

As shown by Lum2 in FIG. 7, even in the case where incidence light is irradiated at a deep incidence angle and the distance to the measurement surface has varied by ΔD, the width of deviation between the center of reflection light reflected in the regular reflection direction and the center of the light receiving unit 1202 is small.

Consequently, in the case where the distance between the regular reflection light measuring apparatus and the measurement surface varies, by configuring the regular reflection light measuring apparatus so that the incidence angle becomes deeper, the variation in the quantity of light to be measured by the light receiving unit 1202 is reduced and it is possible to perform measurement of regular reflection light stably.

Further, in the case of a deep incidence angle, it is possible to reduce the width of the regular reflection light measuring apparatus 12 denoted by DW in FIG. 6 and FIG. 7 more than in the case of a shallow incidence angle, and therefore, the apparatus can be downsized. Furthermore, in the case of a deep incidence angle, it is also possible to reduce the irradiation area of incident light denoted by PW in FIG. 6 and FIG. 7 more than in the case of a shallow incidence angle, and therefore, the measurement patch image size that is necessary is reduced, resulting in saving in toner and sheets necessary for measurement.

In FIG. 7, the example of arrangement is shown in which the incidence angle θ is 20 degrees, however, the incidence angle is not limited to this, and any angle may be accepted with which the quantity of received light to be measured by the light receiving unit 1202 becomes stable in the case where the distance from the regular reflection light measuring apparatus to the measurement surface varies.

### (Method for Selecting Toner Color Suitable to Glossiness Measurement)

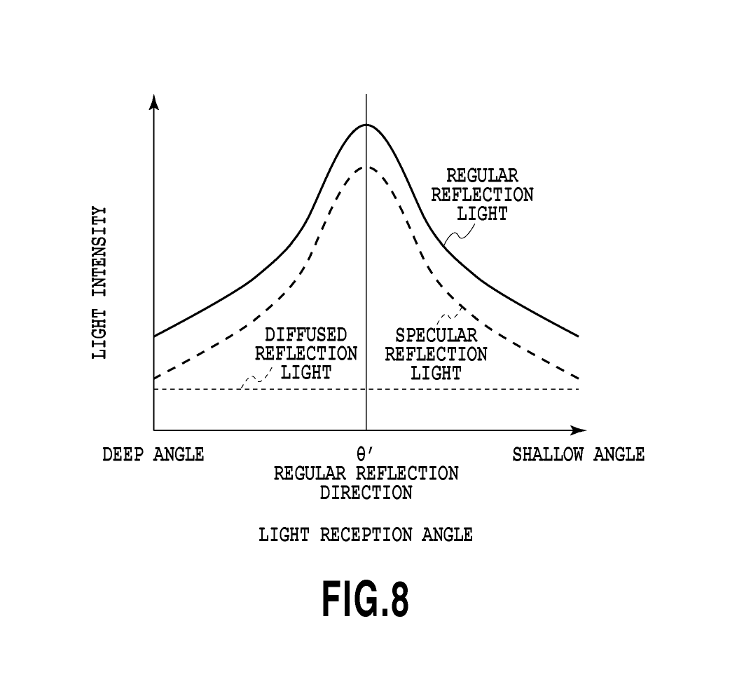

FIG. 8 is a graph representing an intensity distribution of reflection light in the regular reflection direction with the light reception angle θ′ as a center in the case where the measurement surface is irradiated with light at the incidence angle θ. As shown in FIG. 8, the regular reflection light reflected in the regular reflection direction from the measurement surface includes diffused reflection light and specular reflection light (in the present specification, a combination of diffused reflection light and specular reflection light in the regular reflection direction is described as regular reflection light). The diffused reflection light is light that invades the inside of the measurement surface and is absorbed and scattered, and then emitted from the surface. The specular reflection light is light that rebounds from the measurement surface in the opposite direction at the same angle as the incidence angle.

In general, glossiness is determined by the intensity of specular reflection light included in regular reflection light and it can be said that the higher the intensity of specular reflection light, the higher the glossiness is. Further, the intensity of specular reflection light differs depending on the surface roughness of the measurement surface and in general, the smoother the measurement surface, the higher the intensity of specular reflection light in the regular reflection direction is and conversely, the coarser the measurement surface, the lower the intensity of specular reflection light in the regular reflection direction is.

It is desirable to measure the intensity of specular reflection light in order to determine glossiness, however, it is not easy to measure the intensity by separating only the specular reflection light from the regular reflection light. Because of this, normally, light is irradiated at an incidence angle that makes the intensity of diffused reflection light ignorable with respect to the intensity of specular reflection light and glossiness is calculated from the intensity of regular reflection light. Further, it is common to adopt an incidence angle of 60 degrees for the glossiness measurement of printed matter by the electrophotographic (EP) recording system.

In the case where regular reflection light is measured with an incidence angle deeper than the angle normally used in order to perform more stable measurement of regular reflection light within the image forming apparatus (specifically, within the regular reflection light measuring apparatus 12), the quantity of specular reflection light to be measured by the light receiving unit is reduced. Consequently, there is a case where the apparent feeling of gloss does not agree with the obtained glossiness because the diffused reflection light becomes the predominant component of the regular reflection light.

Hereinafter, an example is shown in which the glossiness of a gradation image from the non-image part to the solid image (area covered densely with toner) is measured. As a gradation image, an image is used, which has a plurality of gradation patches created on a plain sheet by the EP system using black toner, and in which the non-image part has the lowest feeling of gloss and the apparent feeling of gloss becomes higher toward the solid image.

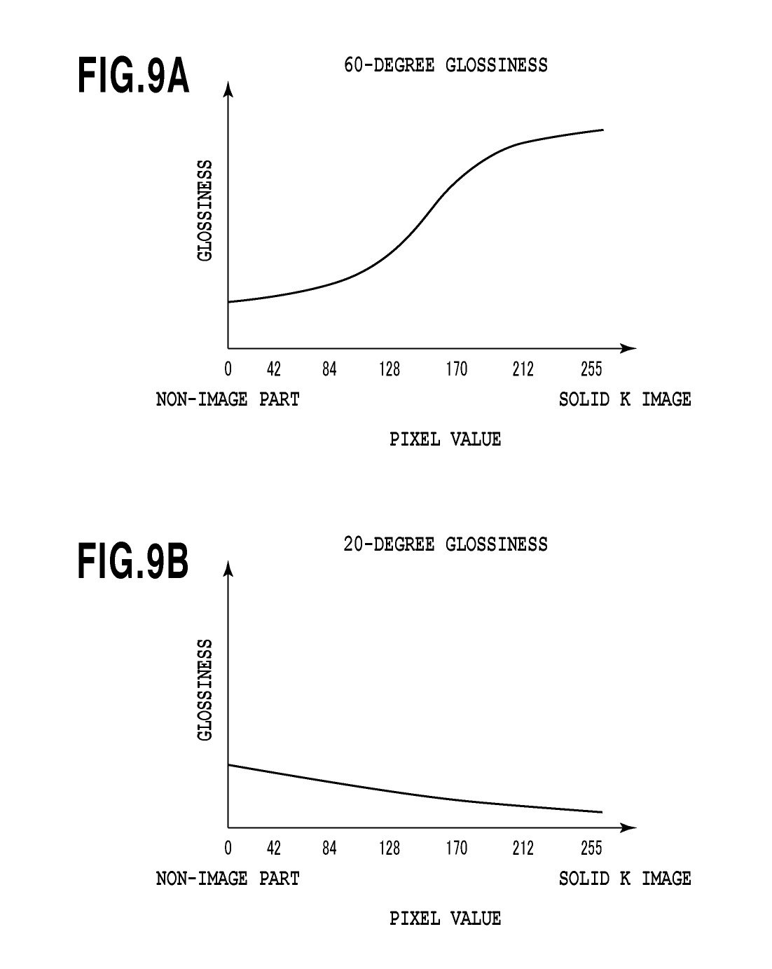

FIG. 9A and FIG. 9B are graphs each representing the characteristic of 60-degree glossiness and 20-degree glossiness in a K monochrome gradation pattern image. In the 60-degree glossiness shown in FIG. 9A, the glossiness is the lowest in the non-image part and the glossiness becomes higher toward the solid K image (area covered densely with black toner). This trend agrees with the apparent feeling of gloss. On the other hand, in the 20-degree glossiness shown in FIG. 9B, the calculated glossiness becomes lower from the non-image part toward the solid K image and this trend does not agree with the apparent feeling of gloss.

In the present invention, in order to solve such a problem described above that the calculated glossiness does not agree with the apparent glossiness, the glossiness is acquired by using a coloring material with which the difference between the diffused reflection light of the non-image part and the diffused reflection light of the solid image is small.

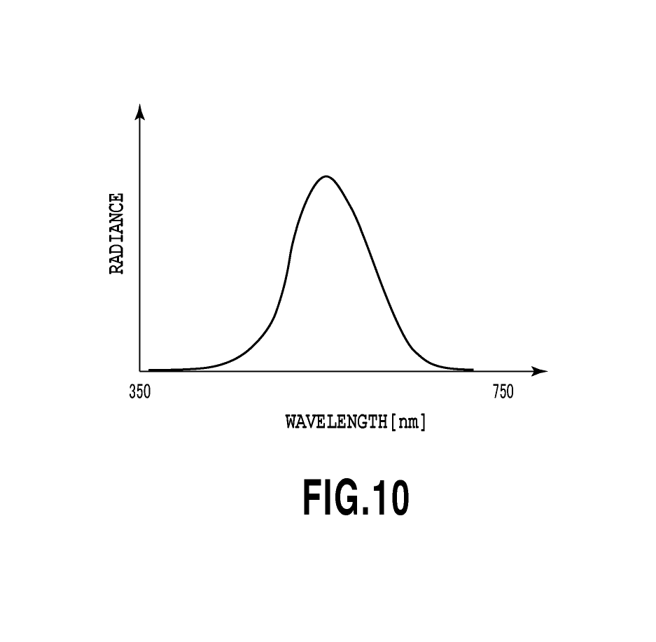

In the present embodiment, as alight source, a light source whose spectral radiance of the light emitting unit 1201 in the regular reflection light measuring apparatus 12 is equivalent to a coupling of a D65 light source, which is the standard light source, and the spectral luminous efficiency (see FIG. 10) is used.

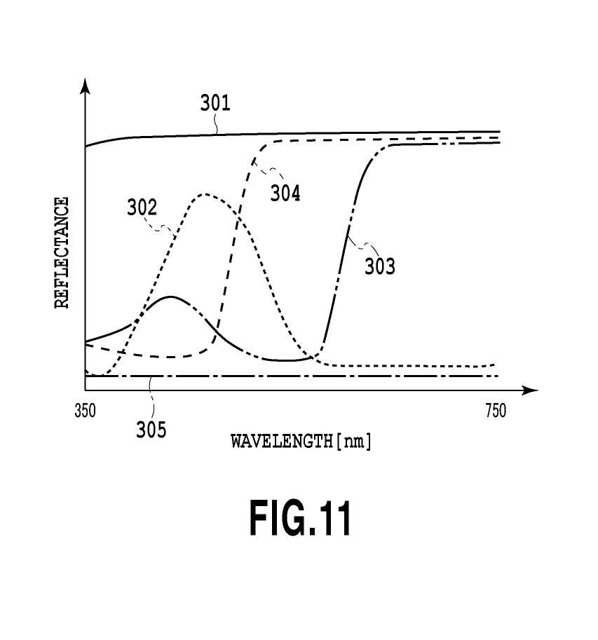

FIG. 11 shows the spectral reflectance of the non-image part and the solid image of toner of each of C, M, Y, and K. The spectral reflectance is a ratio of the intensity of light having each wavelength measured in the case where the measurement surface is irradiated with light by taking the reflectance of each wavelength in the case where the ideal non-image surface is irradiated with light to be 1. In FIG. 11, a spectral reflectance 301 for the non-image part, a spectral reflectance 302 for the solid C image, a spectral reflectance 303 for the solid M image, a spectral reflectance 304 for the solid Y image, and a spectral reflectance 305 for the solid K image are shown.

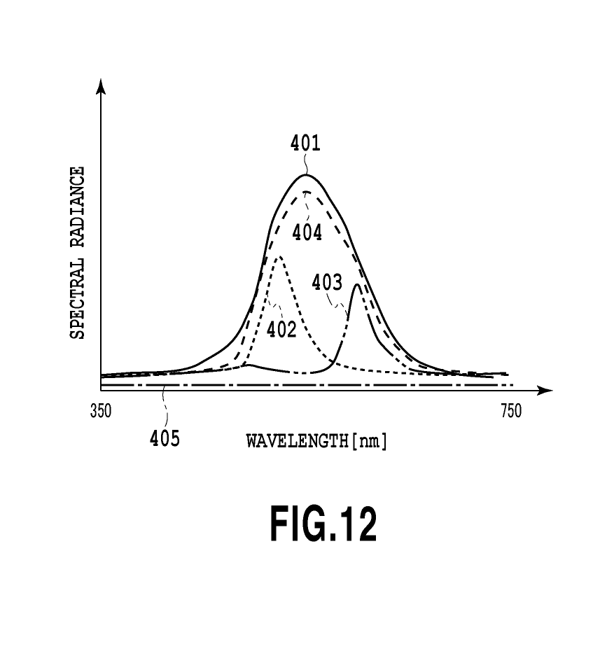

Further, FIG. 12 shows the spectral radiance of diffused reflection light in the case where the non-image part and the solid images of toner of each of C, M, Y, and K having the spectral reflectance characteristics shown in FIG. 11 are irradiated with light using the light emitting unit having the spectral radiance characteristic shown in FIG. 10. In FIG. 12, a spectral radiance 401 of diffused reflection light for the non-image part and spectral radiances 402 to 405 of diffused reflection light for the solid C image, the solid M image, the solid Y image, and the solid K image are shown. Here, the spectral radiance is an amount of energy for each wavelength of light in the unit area and in the unit solid angle.

In the combination of the light emitting unit and each toner used in the present embodiment, the toner with which the difference between the diffused reflection light of the non-image part and the diffused reflection light of the solid image is small is the yellow toner (401 and 404 in FIG. 12). Here, the difference in diffused reflection light is determined from the difference in CIELab chromaticity (CIELab chromaticity difference) obtained from the spectral radiance. It may also be possible to use other indexes, such as the root mean square of the difference in spectral radiance.

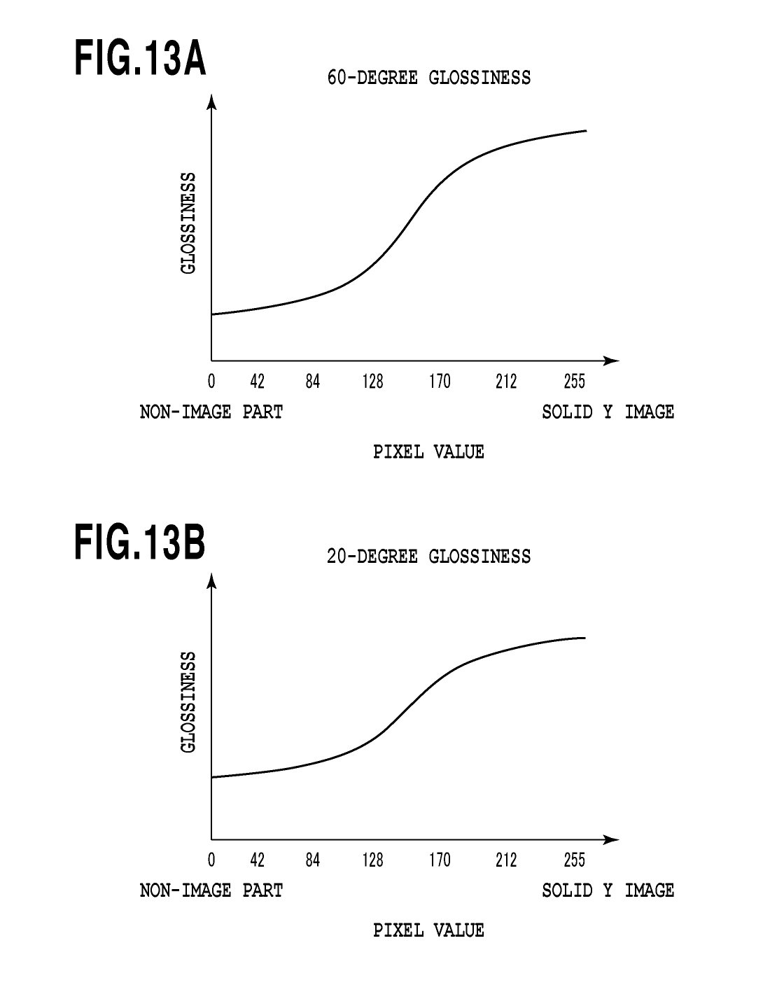

Hereinafter, examples are shown in which glossiness of a plurality of gradation images from the non-image part to the solid Y image is measured. FIG. 13A and FIG. 13B are graphs representing the characteristic of 60-degree glossiness and the characteristic of 20-degree glossiness, respectively, in a Y monochrome gradation pattern image created on a plain sheet using yellow toner. In the 60-degree glossiness shown in FIG. 13A, the glossiness of the non-image part is the lowest and the glossiness becomes higher toward the solid image. Similarly, in the 20-degree glossiness shown in FIG. 13B, the glossiness of the non-image part is the lowest and the glossiness becomes higher toward the solid image. This trend agrees with the apparent feeling of gloss, and therefore, it is known that the change in glossiness at each gradation can be measured even in the case of a deep incidence angle (20 degrees).

In the present embodiment, as alight source, a light source having the spectral radiance characteristic equivalent to the coupling of the D65 light source, which is the standard light source, and the spectral luminous efficiency is used and as a coloring material with which the difference between the diffused reflection light of the non-image part and the diffused reflection light of the image part is small, yellow toner is used. However, the combination of the light source and the coloring material is not limited to this. Any combination of a light source and a coloring material may be used as long as the change in diffused reflection light between the non-image part and the image part is sufficiently small compared to the change in specular reflection light between the non-image part and the image part. For example, a combination of a blue light source and cyan toner, a combination of a red light source and yellow toner, a combination of a red light source and magenta toner, etc., may be used.

Further, the glossiness measurement is not limited to a monochrome image, and it is possible to measure the glossiness of a multicolor image as long as the image is formed by a combination of toner of colors with which the difference between the diffused reflection light of the non-image part and the diffused reflection light of the image part is small for the light source wavelength. For example, by measuring regular reflection light using a red light source for an image created using yellow and magenta and in which gradation changes in the second color, and by determining glossiness, it is possible to measure the change in glossiness for each gradation from the non-image part to the solid second color image.

In the present embodiment, as a light source, a light source that emits light having a wavelength with which the change in diffused reflection light between the non-image part and the image part is small compared to the change in specular reflection light between the non-image part and the image part with regard to toner of at least one color is used.

Further, in the present embodiment, the toner with which the difference between the spectral radiance of the non-image part and the spectral radiance of the toner image part is the smallest is determined using the spectral radiance of the solid image part, however, the toner determining method is not limited to this method. It may also be possible to determine toner with which the change in diffused reflection light between the non-image part and the image part is sufficiently small compared to the change in specular reflection light between the non-image part and the image part from the spectral radiance measured in another gradation image or from a predicted value calculated from the absorption/transmission characteristics of the toner.

The combination of the light source and the toner with which the change in diffused reflection light between the non-image part and the image part is sufficiently small compared to the change in specular reflection light between the non-image part and the image part remains the same, and therefore, it is not necessary to make a selection each time glossiness measurement is performed. Consequently, the combination of the light source and the toner selected in advance may be used.

In the first embodiment 1, even in the case where glossiness is measured with a deep incidence angle, an image is measured, which is formed by toner of a color with which the difference in diffused reflection light between the non-image part and the image part is sufficiently small compared to the difference in specular reflection light between the non-image part and the image part of toner of a plurality of colors. Due to this, it is possible to measure glossiness with high accuracy. It is possible to apply the measurement data to various kinds of techniques that utilize the change in glossiness of an image for each gradation. For example, it is possible to apply the measurement data to a technique for obtaining a color image the gloss of which is uniform regardless the gradation of the image, and therefore, which gives a favorable impression by setting image forming conditions, such as fixing temperature, so that the difference between the maximum glossiness and the minimum glossiness in a pattern image is equal to or less than a predetermined value based on the glossiness measurement data.

### Second Embodiment

In the first embodiment, the case is explained where the glossiness at the same gradation is equal regardless of the color of toner. Because the glossiness at the same gradation is equal regardless of the color of toner, it is possible to apply the glossiness measured with an image of toner, which is part of toner of a plurality of colors, as the glossiness of another toner image.

However, for example, in the case where the amount of attached toner for each gradation or the fusing point of toner differs depending on the color of toner, there is a possibility that the coarseness of the surface roughness changes, and therefore, the glossiness differs even for the same gradation.

Because of this, in order to embody the present invention more effectively, an image forming apparatus for measuring glossiness of toner for each color is explained below.

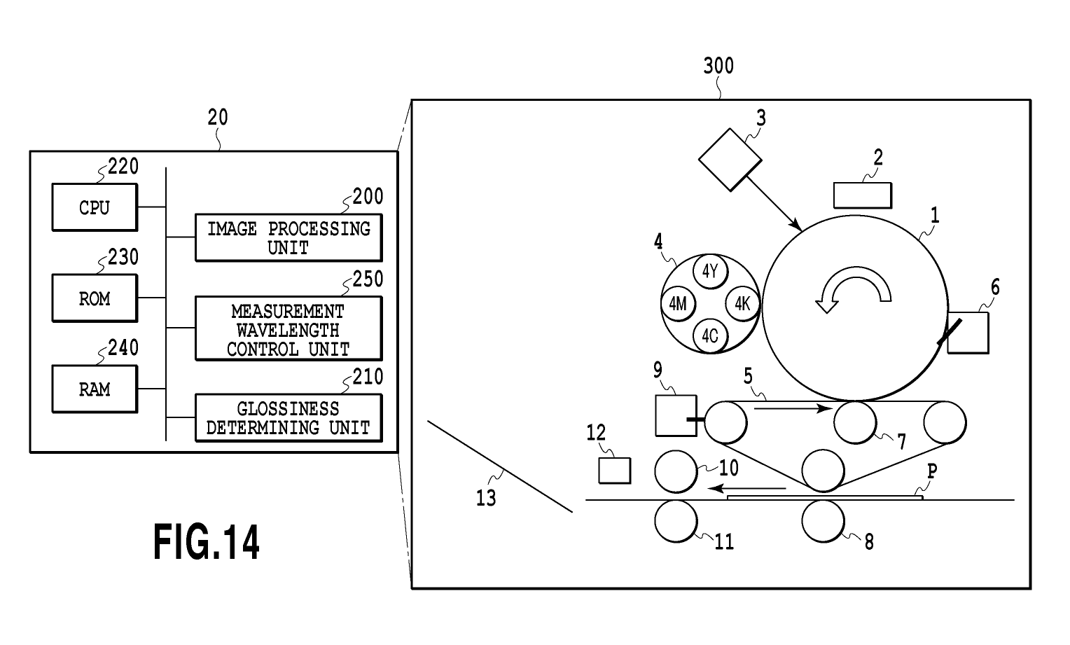

FIG. 14 is a diagram showing a configuration of the image forming apparatus according to the present embodiment. The controller 20 of the image forming apparatus includes a measurement wavelength control unit 250 and controls a light source of the regular reflection light measuring apparatus 12 in accordance with the color of toner of a pattern image created in the image forming unit 300.

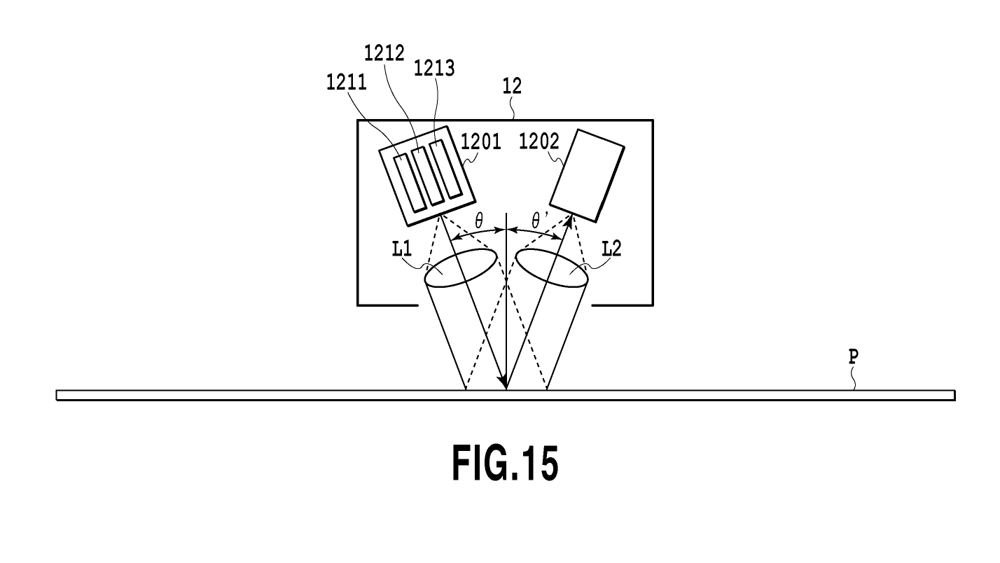

Next, the configuration example of the regular reflection light measuring apparatus 12 in FIG. 14 is explained in detail. FIG. 15 is a schematic configuration diagram showing the configuration of the regular reflection light measuring apparatus 12 in FIG. 14. The lens L1, the lens L2, and the light receiving unit 1202 each have the same configuration as that shown in FIG. 3, and therefore, explanation is omitted. The light emitting unit 1201 has a plurality of light sources having different wavelengths (a red light source 1211, a green light source 1212, and a blue light source 1213). By controlling the light emitting light source, it is possible to change the wavelength of light with which to measure glossiness.

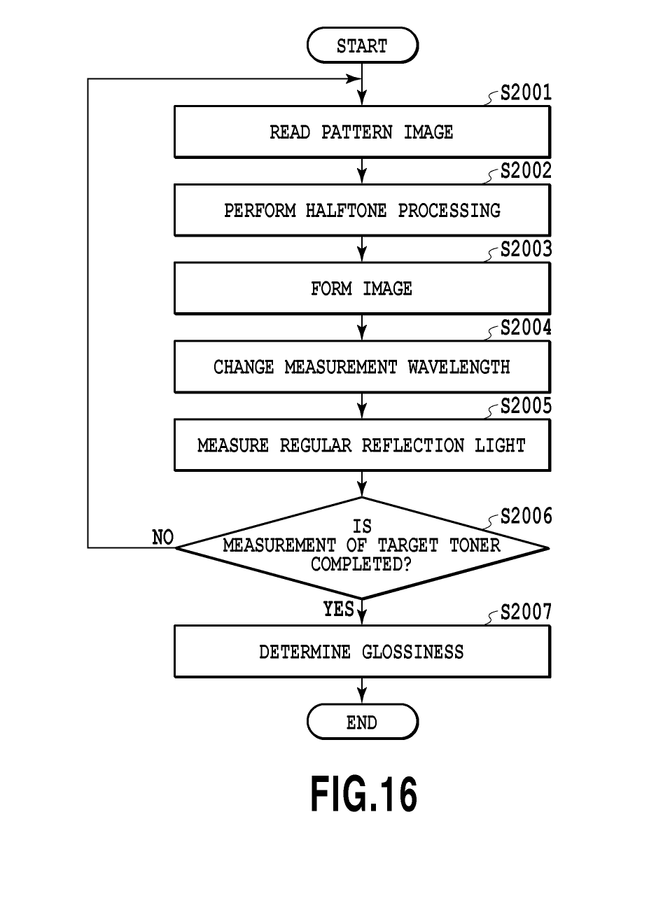

FIG. 16 is a flowchart for explaining a glossiness measurement process according to the present embodiment.

First, a pattern image formed by toner of one color of the toner of a plurality of colors is read (step 2001).

Processing from step S2002 to step S2003 is the same as the above-described processing from step S1002 to step S1003, and therefore, explanation is omitted.

Next, the measurement wavelength control unit 250 changes the light source of the light emitting unit 1201 of the regular reflection light measuring apparatus 12 in accordance with the color of the toner of the pattern image read at step S2001 (step S2004). At this time, the light source is changed to a light source with which the change in diffused reflection light between the non-image part and the image part is sufficiently small compared to the change in specular reflection light between the non-image part and the image part. For example, at the time of measurement of regular reflection light of a cyan toner image, the light source is changed to a blue light source, at the time of measurement of regular reflection light of a yellow toner image, the light source is changed to a green light source, and at the time of measurement of regular reflection light of a magenta toner image, the light source is changed to a red light source. Due to this, the change in diffused reflection light is reduced in each kind of toner and it is made possible to acquire glossiness with high accuracy. The previously-described combination of the color of the light source and the toner is one of examples and it is possible to use any light source with which the difference in diffused reflection light between the non-image part and the image part is small for each kind of toner.

Next, the regular reflection light whose wavelength is changed at step S2004 is measured by using the regular reflection light measuring apparatus 12 (step S2005).

Next, whether the measurement of regular reflection light is completed for all the pattern images of the target toner is determined (S2006). In the case where the measurement of regular reflection light is not completed yet for all the pattern images of the target toner, the operations from step S2001 to step S2006 are repeated and the measurement of regular reflection light of pattern images of toner of another color is performed.

In the case where the measurement of regular reflection light for all the pattern images of the target toner is completed, the glossiness determining unit 210 determines glossiness for each gradation of toner of each color (step S2007). The determining method is the same as that of the first embodiment. The target toner referred to in the present embodiment is the toner having a light source with which the change in diffused reflection light between the non-image part and the image part is sufficiently small compared to the change in specular reflection light between the non-image part and the image part. The glossiness of the toner having no light source that satisfies this condition is determined from the intensity of regular reflection light of the image of toner of another color as in the first embodiment.

In the present embodiment, as the way to change the measurement wavelength of regular reflection light, the example is shown in which the light source of the light emitting unit is changed, however, the way to change the measurement wavelength of regular reflection light is not limited to this. For example, it may also be possible to install a color filter configured to transmit light having a wavelength with which the difference in diffused reflection light between the non-image part and the image part is sufficiently small compared to the difference in specular reflection light between the non-image part and the image part on the light path between the light emitting unit 1201 and the light receiving unit 1202 in FIG. 3. By providing a plurality of color filters configured to transmit light having different wavelengths in the regular reflection light measuring apparatus 12, it is possible to change the measurement wavelength by changing the color filter in accordance with the color of the coloring material of the image to be measured.

Preferably, the difference in the quantity of received light in the light receiving unit that changes accompanying the change of the light source or the color filter is calibrated from the measurement value at the same measurement surface.

### Third Embodiment

In the second embodiment, the method for measuring the intensity of regular reflection light having a wavelength with which the change in diffused reflection light between the non-image part and the image part is sufficiently small compared to the change in specular reflection light between the non-image part and the image part by changing the light source of the light emitting unit is explained.

In the present embodiment, glossiness is determined using the intensity of regular reflection light having a wavelength with which the difference in diffused reflection light between the non-image part and the image part is sufficiently small compared to the difference in specular reflection light between the non-image part and the image part by separating regular reflection light reflected from the measurement surface according to wavelength and by measuring the intensity of regular reflection light. The configuration of the image forming apparatus in the present embodiment is the same as that of the first embodiment, and therefore, explanation is omitted.

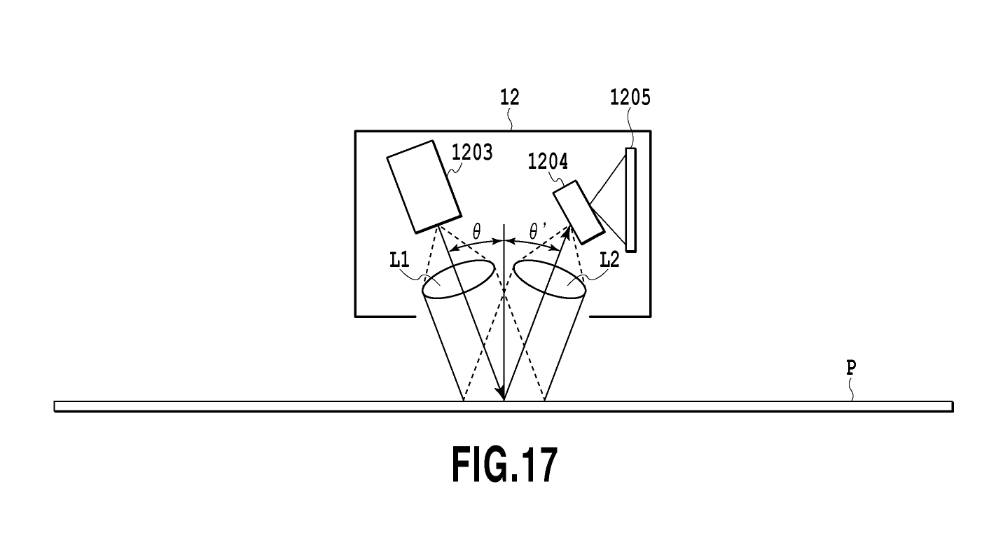

FIG. 17 is a schematic configuration diagram showing a configuration of the regular reflection light measuring apparatus 12 according to the present embodiment. As shown in FIG. 17, the regular reflection light measuring apparatus 12 includes a light emitting unit 1203, the lens L1, the lens L2, a light separating unit 1204, and a light receiving unit 1205.

The light emitting unit 1203 is a light source having emission spectra existing in the entire visible light region, such as a white LED and a halogen lamp. The light separating unit 1204 is a spectroscope capable of separating light according to wavelength, such as a diffraction lattice and a prism. The light receiving unit 1205 is a line sensor having a plurality of light receivers.

Light irradiated from the light source of the light emitting unit 1203 turns into parallel light through the lens L1 and is reflected from the measurement surface P and the light reflected in the regular reflection direction is condensed through the lens L2 and separated by the spectroscope 1204. After that, the separated light enters the different light receivers of the line sensor 1205 according to wavelength. The line sensor 1205 measures the intensity of light having a difference wavelength incident on each light receiver.

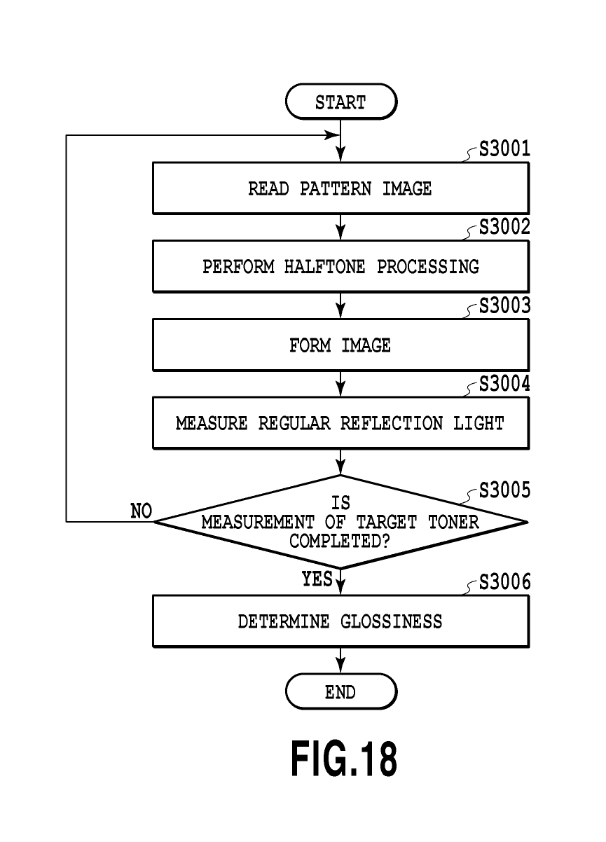

FIG. 18 is a flowchart for explaining a glossiness measurement process according to the present embodiment.

First, a pattern image formed by toner of one color of toner of a plurality of colors is read (step S3001).

The processing from step S3002 to step S3003 is the same as the processing from step S1002 to step S1003 described above, respectively, and therefore, explanation is omitted.

Next, by using the regular reflection light measuring apparatus 12 shown in FIG. 17, the intensity of regular reflection light of the patch image with each gradation formed at step S3003 is measured by separating the regular reflection light according to wavelength (step S3004).

Next, whether the measurement of regular reflection light is completed for all the pattern images of the target toner is determined (S3005). In the case where the measurement of regular reflection light is not completed yet for all the pattern images of the target toner, the operations from step S3001 to step S3005 are repeated and the measurement of regular reflection light of pattern images of toner of another color is performed.

In the case where the measurement of regular reflection light for all the pattern images of the target toner is completed, the glossiness determining unit 210 determines glossiness for each gradation of toner of each color (step S3006).

In the glossiness determining unit 210 in the present embodiment, the wavelength of regular reflection light used at the time of determination of glossiness differs depending on the color of toner of the formed image. It is possible to determine glossiness without being affected by diffused reflection light by selecting regular reflection light having a wavelength with which the difference in diffused reflection light between the non-image part and the image part is sufficiently small compared to the difference in specular reflection light between the non-image part and the image part from among the wavelengths used for measurement and by using the intensity of the selected regular reflection light.

The target toner referred to in the present embodiment is the toner for which there exists a wavelength of regular reflection light with which the change in diffused reflection light between the non-image part and the image part is sufficiently small compared to the change in specular reflection light between the non-image part and the image part. The glossiness of the toner for which there is no wavelength that satisfies this condition is determined from the intensity of regular reflection light of the image of toner of another color as in the first embodiment.

### Fourth Embodiment

### Execution Timing

The measurement of glossiness in the present invention is performed with a timing at which a user specifies glossiness measurement from an application. By this execution, a pattern image for glossiness measurement is formed and the glossiness of the image in accordance with a sheet is measured by the regular reflection light measuring apparatus 12. However, the previously-described execution timing of the measurement of glossiness is one of examples and the glossiness measurement may be performed with a timing at which a sheet is set newly in the feed tray or a timing in accordance with the elapsed time or the number of printed sheets.

### (Kind of Coloring Material)

The image forming apparatus for embodying the present invention may mount toner (coloring material or recording agent) other than the C, M, Y, and K toner described in the first embodiment and in the second embodiment. Specifically, even in the case where toner of a pale color having a relatively high brightness than that of the above-mentioned C, M, Y, and K toner or transparent toner is mounted, it is possible to embody the present invention.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-079422, filed Apr. 5, 2013, which is hereby incorporated by reference herein in its entirety.

What is claimed is:

1. An image forming apparatus for forming an image using coloring materials of a plurality of colors, the apparatus comprising:
a measuring unit configured to measure regular reflection light of an image formed by a coloring material of a color with which a difference in diffused reflection light between a non-image part and an image part on a recording medium is relatively small compared to a difference in specular reflection light of the coloring materials of the plurality of colors at an angle by which a quantity of received light to be measured by a light receiving unit becomes stable in a case where distance between the light receiving unit and a measurement surface varies; and
a determining unit configured to determine glossiness based on the intensity of the regular reflection light measured by the measuring unit.

2. The image forming apparatus according to claim 1, wherein
the formed image is formed by a yellow coloring material.

3. The image forming apparatus according to claim 1, further comprising a control unit configured to change a measurement wavelength of regular reflection light, wherein
the control unit changes a measurement wavelength to a wavelength with which the difference in diffused reflection light is relatively small compared to the difference in specular reflection light in accordance with a color of a coloring material of the formed image.

4. The image forming apparatus according to claim 3, wherein
the measuring unit comprises a plurality of light sources causing light having different wavelengths to enter the formed image and a light receiving unit configured to receive regular reflection light reflected from the formed image, and
the control unit changes a light source to be used to a light source having a wavelength with which the difference in diffused reflection light is relatively small compared to the difference in specular reflection light in accordance with a color of a coloring material of the formed image.

5. The image forming apparatus according to claim 3, wherein
the measuring unit comprises a light emitting unit configured to cause light to enter the formed image, a plurality of color filters configured to transmit light having different wavelengths, and a light receiving unit configured to receive regular reflection light reflected from the formed image, and
a color filter configured to transmit light having a wavelength with which the difference in diffused reflection light is relatively small compared to the difference in specular reflection light is installed on a light path of regular reflection light in accordance with a color of a coloring material of the formed image.

6. The image forming apparatus according to claim 1, wherein
the measuring unit comprises a light emitting unit configured to cause light to enter the formed image, a light separating unit configured to separate regular reflection light reflected from the formed image according to wavelength, and a light receiving unit configured to measure the intensity of regular reflection light separated by the light separating unit, and
the determining unit determines glossiness by using regular reflection light having a wavelength with which the difference in diffused reflection light is relatively small compared to the difference in specular reflection light from among separated regular reflection light received by the light receiving unit in accordance with a color of a coloring material of the formed image.

7. The image forming apparatus according to claim 1, wherein
the angle is 20 degrees or less.

8. An apparatus for measuring an image formed using coloring materials of a plurality of colors, wherein
glossiness is determined by measuring regular reflection light of an image formed by a coloring material of a color with which a difference in diffused reflection light between a non-image part and an image part on a recording medium is relatively small compared to a difference in specular reflection light of the coloring materials of the plurality of colors at an angle by which a quantity of received light to be measured by a light receiving unit becomes stable in a case where distance between the light receiving unit and a measurement surface varies, and
the determined glossiness is applied as glossiness of an image formed by a coloring material other than the coloring material of the color.

9. An image forming method for forming an image using coloring materials of a plurality of colors, the method comprising the steps of:
measuring regular reflection light of an image formed by a coloring material of a color with which a difference in diffused reflection light between a non-image part and an image part on a recording medium is relatively small compared to a difference in specular reflection light of the coloring materials of the plurality of colors at an angle by which a quantity of received light to be measured by a light receiving unit becomes stable in a case where distance between the light receiving unit and a measurement surface varies by a measuring unit; and
determining glossiness based on the intensity of the regular reflection light measured in the step of measuring regular reflection light by a determining unit.

10. A non-transitory computer readable storage medium storing a program for causing a computer to function as the image forming apparatus according to claim 1.
